(19) United States
(12) Patent Application Publication
(10) Pub. No.: US 2006/0108015 A1
(43) Pub. Date: May 25, 2006

(54) Seal or Fluid Barrier Using Strands

(75) Inventors: Mitchell Price, Swalwell (CA); Nathan Kathol, Chestermere (CA); Craig Skeates, Calgary (CA); Peter Krawiec, Bonnyville (CA)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 10/904,722

(22) Filed: Nov. 24, 2004

(51) Int. Cl. F16L 55/10

(52) U.S. Cl. 138/89

(57) ABSTRACT

The present invention provides for a seal or barrier comprising strands that are woven or wrapped in an overlapping manner such as, for example, helical or circumferential patterns.

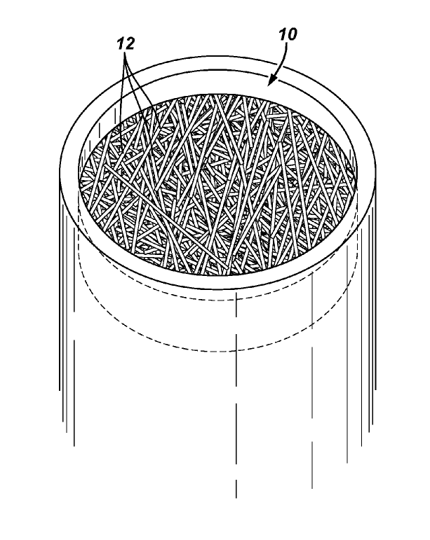

### BACKGROUND

1. Field of Invention

The present invention pertains to seals and barriers used in subsurface wells, and particularly to seals/barriers formed from material strands.

2. Related Art

It is often desirable to block or restrict the flow of fluids or solid particulates in a well. For example, a seal between a downhole tool and a well casing such as is commonly found in a packer may be used to prevent or restrict fluid flow between formations. A tool may also require a seal or fluid barrier within the internal structure of the tool, say between an inner mandrel and an outer housing.

In the prior art, braided rope packing has been used to form a seal element or barrier for downhole tools, particularly in valves. The packing is cut and wrapped around a mandrel in a mold and pressed into a desired shape. The rope packing holds that shape while being installed over a mandrel or into a tool. Compressing the braided rope packing creates a seal or barrier. Elastomers, cast or milled to a desired shape, have also been used to form a seal element or barrier in downhole tools.

### SUMMARY

The present invention provides for a seal or barrier comprising strands that are woven or wrapped in an overlapping manner such as, for example, helical or circumferential patterns.

Advantages and other features of the invention will become apparent from the following description, drawings, and claims.

### BRIEF DESCRIPTION OF THE DRAWING

The FIGURE is a plan view of a seal or fluid/solids barrier constructed in accordance with the present invention.

### DETAILED DESCRIPTION

Referring to the FIGURE, a seal or fluid barrier 10 comprises strands 12 woven in a overlapping or mesh pattern. The pattern may be helical, circumferential, orthogonal, or some other arrangement of strands 12. Strands 12 are preferably metal, but could be some other natural or synthetic material such as nylon or fabric with a polytetrafluoroethylene laminate (e.g., GORE-TEX®). Strands 12 may be circular or angular in cross-section and may be of various lengths. Variations in the strand cross-sections and lengths can be used to meet particular performance objectives. Strands 12 may be impregnated or coated with an elastomer or other conformable material to form a composite seal or barrier 10. In an alternative embodiment, in place of woven strands, smaller, shorter strands 12 can be simply layered and pressed into a desired shape to form seal 10.

In operation, seal 10 is installed on or in a tool and compressed to block or restrict the passage of fluid therethrough. Seal 10 can be used to isolate wellbore fluids, hold pressure, prevent sand production, or allow sufficiently small particles to pass through. Seal 10 may be used to support cement or to plug a wellbore, for example, when the wellbore is to be plugged and abandoned. For sand retention, the weaving density and setting force can be varied to produce the desired pore space in seal 10. By controlling the pore space and permeability of seal 10, a fluid barrier may be obtained by creating a labyrinth effect or tortuous path for fluid flow, thereby effectively preventing fluid communication.

Using various metals and/or other materials to weave or otherwise form seal 10, seal 10 can be used in various wellbore environments. Those environments include, but are not limited to, extremely low or high temperature wellbores, or highly corrosive or relatively non-corrosive wellbore environments. Pressure holding requirements may vary from an absolute seal to one in which fluid flow is merely restricted. Seal 10 can be used in such widely differing applications by adjusting the setting (compressive) force applied.

Depending on the shape and length of seal 10, seal 10 can be run through small diameter openings (e.g., one inch) and set in a wide range of outer diameters. For example, seal 10 may be run through tubing, but set in casing. Seal 10 can be used over many different casing sizes and weight ranges, thus reducing the number of designs required. In addition, seal 10 can be used in wellbore applications in which impairments exist in the casing that restrict access by standard oilfield tools.

Although only a few example embodiments of the present invention are described in detail above, those skilled in the art will readily appreciate that many modifications are possible in the example embodiments without materially departing from the novel teachings and advantages of this invention. Accordingly, all such modifications are intended to be included within the scope of this invention as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A seal for use in a well comprising strands placed in an overlapping arrangement.

2. The seal of claim 1 in which the strands are made of metal.

3. The seal of claim 1 in which the strands are made of a synthetic material.

4. The seal of claim 1 in which the strands are woven.

5. The seal of claim 4 in which the woven strands are woven in a helical pattern.

6. The seal of claim 4 in which the woven strands are woven in a circumferential pattern.

7. The seal of claim 4 in which the woven strands are woven in an orthogonal pattern.

8. The seal of claim 1 in which the strands have a circular cross-section.

9. The seal of claim 1 in which the strands have an angular cross-section.

10. The seal of claim 1 in which the strands are impregnated or coated with a conformable material.

11. A method to seal a well having a casing comprising:
running a seal element comprising strands through a tubular having a smaller diameter than the casing; and
compressing the seal element to force it into sealing engagement with the casing.

12. A method to block or restrict fluid flow in a well having a casing comprising:
wrapping a seal element comprising strands around a sealing surface on a tool to be placed downhole;
running the tool into the well to a desired location; and
compressing the seal element such that it is in sealing engagement with the sealing surface of the tool and the casing.

13. A method to block or restrict fluid flow within a downhole tool comprising:
wrapping a seal element comprising strands around an inner sealing surface within the tool; and
compressing the seal element such that it is in sealing engagement with the inner sealing surface and an outer sealing surface within the tool.
